(19) United States
(12) Patent Application Publication
(10) Pub. No.: US 2024/0318492 A1
(43) Pub. Date: Sep. 26, 2024

(54) BLENDED WOOD EXTERIOR DOOR JAMB

(71) Applicant: William-MacRae and Company, Omaha, NE (US)

(72) Inventor: Colin MacRae Thomson, Issaquah, WA (US)

(21) Appl. No.: 18/680,500

(22) Filed: May 31, 2024

Related U.S. Application Data
(63) Continuation-in-part of application No. 17/540,831, filed on Dec. 2, 2021.
(60) Provisional application No. 63/505,578, filed on Jun. 1, 2023.
(60) Provisional application No. 63/120,527, filed on Dec. 2, 2020.
(60) Provisional application No. 63/142,079, filed on Jan. 27, 2021.

(51) Int. Cl. E06B 1/32; B32B 3/30; B32B 7/02; B32B 21/02; B32B 21/08; B32B 27/30; B32B 37/18

(52) U.S. Cl. CPC E06B 1/32; B32B 3/30; B32B 7/02; B32B 21/02; B32B 21/08; B32B 27/304; B32B 37/182; B32B 2255/08; B32B 2255/10; B32B 2307/7376; B32B 2317/16; B32B 2327/06; B32B 2419/00

(57) ABSTRACT

A blended trim molding assembly can include a first layer of engineered wood material (e.g., thermoplastic) having a first, generally rectangular cross-sectional thickness, and a second layer of wood material (e.g., lumber, particle board, fiberboard) having a second, generally rectangular cross-sectional thickness. The second layer of wood material is joined (e.g., glued) to the first layer of engineered wood material/thermoplastic at a planar interface. Together, the first and second layers have a total thickness. The blended trim molding assembly may also include a third layer of wood material having a third, generally rectangular cross-sectional thickness, where the third layer of wood material is joined to the first layer of engineered wood material/thermoplastic at a second planar interface opposite the planar interface.

### CROSS-REFERENCE TO RELATED APPLICATIONS

The present application claims the benefit under 35 U.S.C. § 119(e) of U.S. Provisional Application Ser. No. 63/505,578, filed Jun. 1, 2023, and titled “BLENDED WOOD EXTERIOR DOOR JAMB.” The present application is also a continuation-in-part under 35 U.S.C. § 120 of U.S. patent application Ser. No. 17/540,831, filed Dec. 2, 2021, and titled “BLENDED WOOD INTERIOR DOOR JAMB,” which claims priority under 35 U.S.C. § 119(e) of U.S. Provisional Application Ser. No. 63/120,527, filed Dec. 2, 2020, and titled “DUAL-LAYERED WOOD INTERIOR DOOR JAMB,” and U.S. Provisional Application Ser. No. 63/142,079, filed Jan. 27, 2021, and titled “BLENDED WOOD INTERIOR DOOR JAMB.” U.S. patent application Ser. No. 17/540,831 and U.S. Provisional Application Ser. Nos. 63/120,527; 63/142,079; and 63/505,578 are herein incorporated by reference in their entireties.

### BACKGROUND

Exterior woodwork for buildings, such as residential and commercial housing, includes trim moldings, such as casings used to trim the perimeter of windows, doors, and so forth. For example, a doorframe can include case molding in the form of two upright jambs. A door can be hung on one of the upright jambs. Exterior trim serves to seal out wind and weather and to provide a building with a finished look.

### DRAWINGS

The Detailed Description is described with reference to the accompanying figures. The use of the same reference numbers in different instances in the description and the figures may indicate similar or identical items.

FIG. 1 is a partial isometric view illustrating blended trim molding for an exterior door jamb in accordance with example embodiments of the present disclosure.

FIG. 2 is an obverse isometric view of the blended trim molding illustrated in FIG. 1.

FIG. 3 is a top plan view of the blended trim molding illustrated in FIG. 1.

FIG. 4 is a bottom plan view of the blended trim molding illustrated in FIG. 1.

FIG. 5 is a front elevation view of the blended trim molding illustrated in FIG. 1.

FIG. 6 is a rear elevation view of the blended trim molding illustrated in FIG. 1.

FIG. 7 is a left side elevation view of the blended trim molding illustrated in FIG. 1.

FIG. 8 is a right side elevation view of the blended trim molding illustrated in FIG. 1.

FIG. 9 is an end view illustrating blended trim molding in accordance with example embodiments of the present disclosure.

FIG. 10 is a partial isometric view illustrating blended trim molding for an exterior door jamb that includes dado and hinge cutouts in accordance with example embodiments of the present disclosure.

FIG. 11 is an isometric view illustrating trim moldings, such as the blended trim molding illustrated in FIG. 1, configured as a door jamb set and installed in a rough opening in accordance with example embodiments of the present disclosure.

FIG. 12 is a partial perspective view illustrating blended trim molding in accordance with example embodiments of the present disclosure.

FIG. 13 is an end view illustrating blended trim molding for an exterior door jamb that includes a single rabbet in accordance with example embodiments of the present disclosure.

FIG. 14 is another end view illustrating blended trim molding for an exterior door jamb that includes a single rabbet in accordance with example embodiments of the present disclosure.

FIG. 15 is a further end view illustrating blended trim molding for an exterior door jamb that includes a single rabbet in accordance with example embodiments of the present disclosure.

FIG. 16 is an isometric view of the blended trim molding illustrated in FIG. 13.

FIG. 17 is an isometric view of the blended trim molding illustrated in FIG. 14.

FIG. 18 is an isometric view of the blended trim molding illustrated in FIG. 15.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Exterior millwork for residential and commercial housing are decorative, nonstructural components normally made of strips of wood and used to cover transition areas between surfaces. These components, called “mouldings” or “moldings,” include casings/case moldings, base moldings, and crown moldings, and can be used to trim the perimeter of windows, doors, and other locations. Vertical and horizontal millwork trim pieces that cover door openings are called door jambs. Vertical door jambs bear the weight of the door through applied hinges and latches. Two vertical jamb sides and a head jamb may be referred to as a door jamb set. A door jamb set hinged to a door may be referred to as a prehung door. The accuracy of the plumb and strength of a door jamb is important to the overall operational durability and security of a door. Today, millwork also encompasses items that are made using alternatives to wood, including synthetics, plastics, and wood-adhesive composites. Millwork may be painted or stained (e.g., after installation).

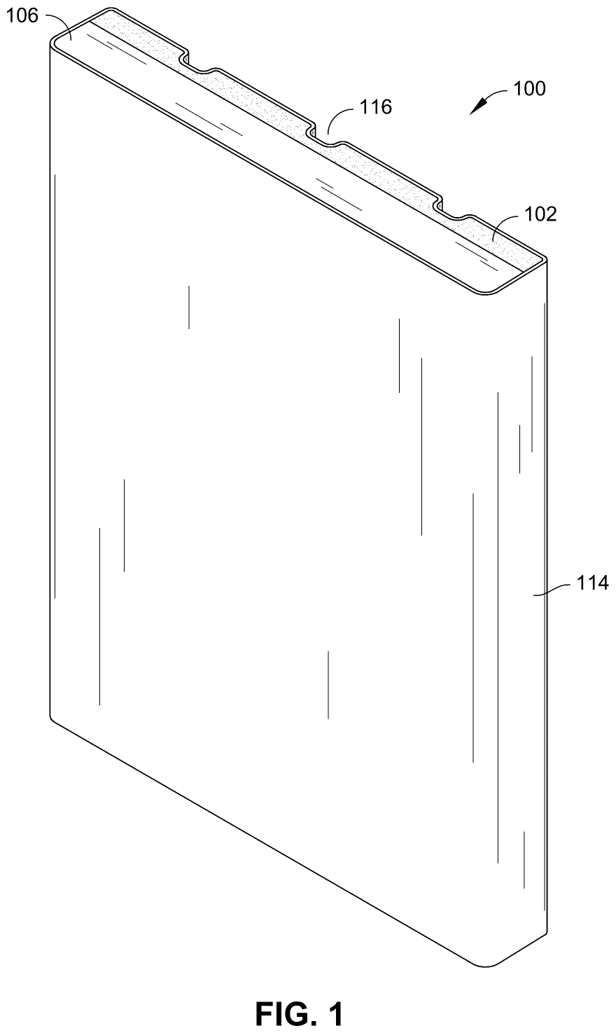

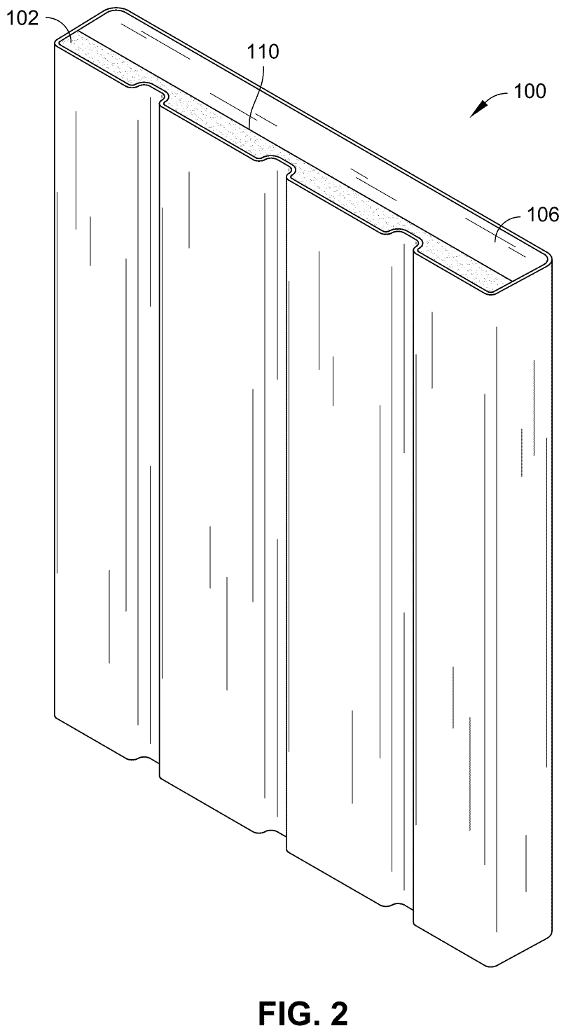

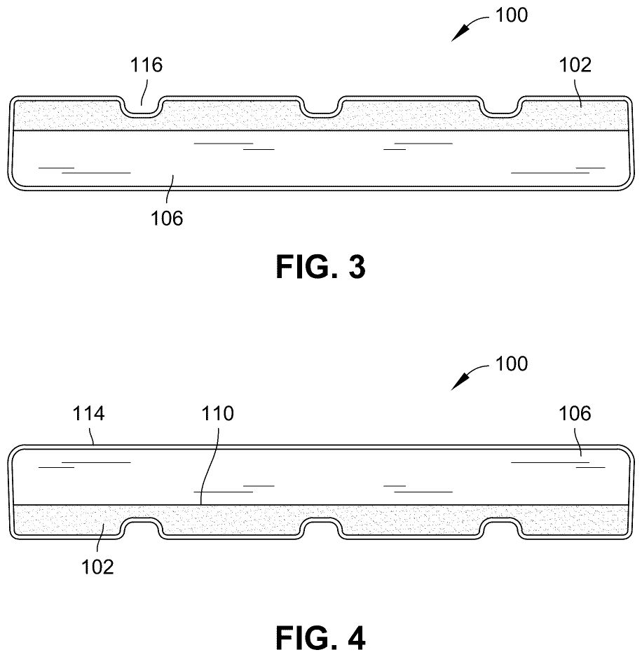

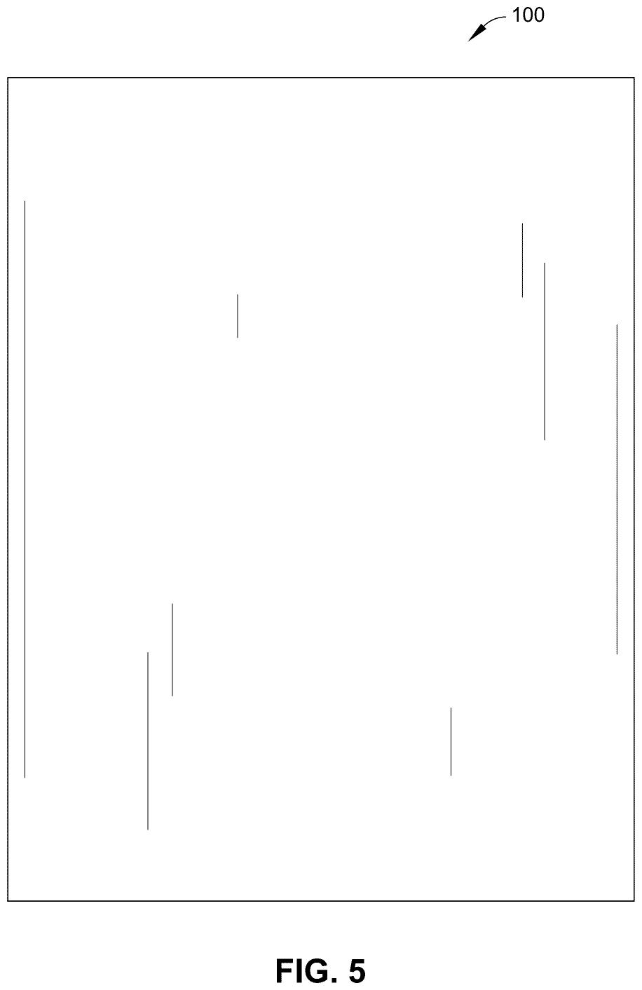

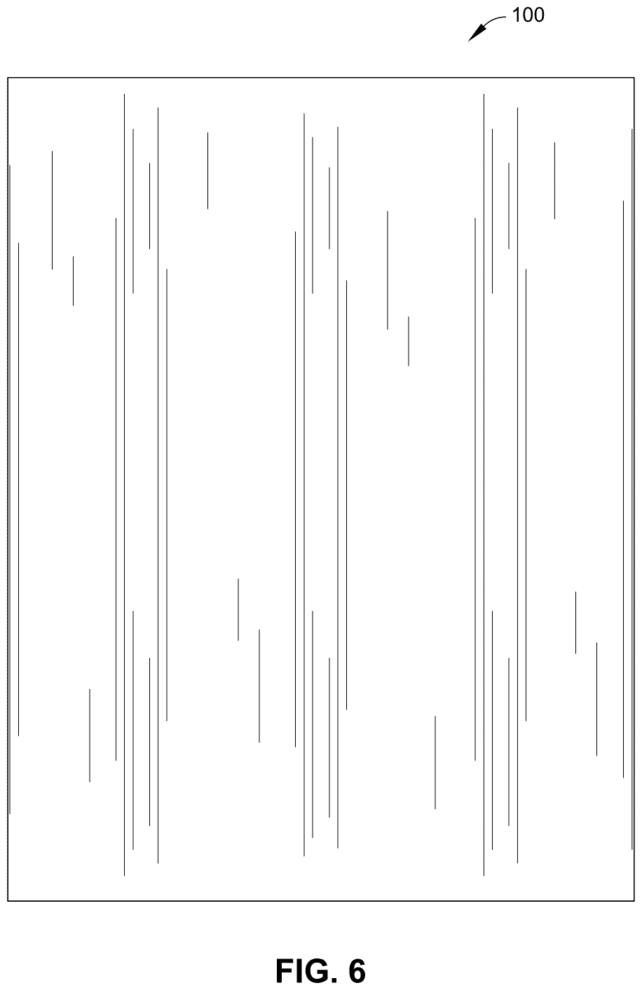

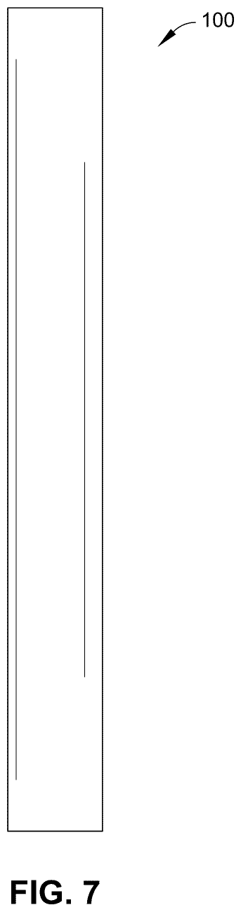

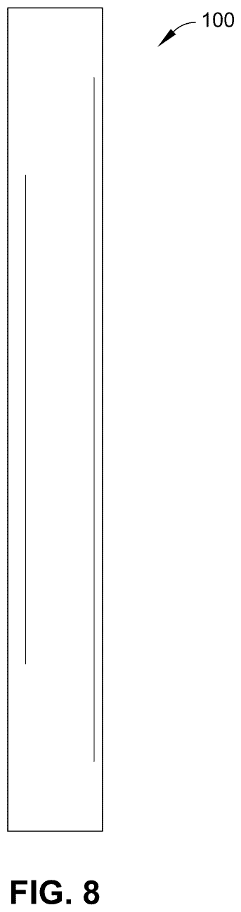

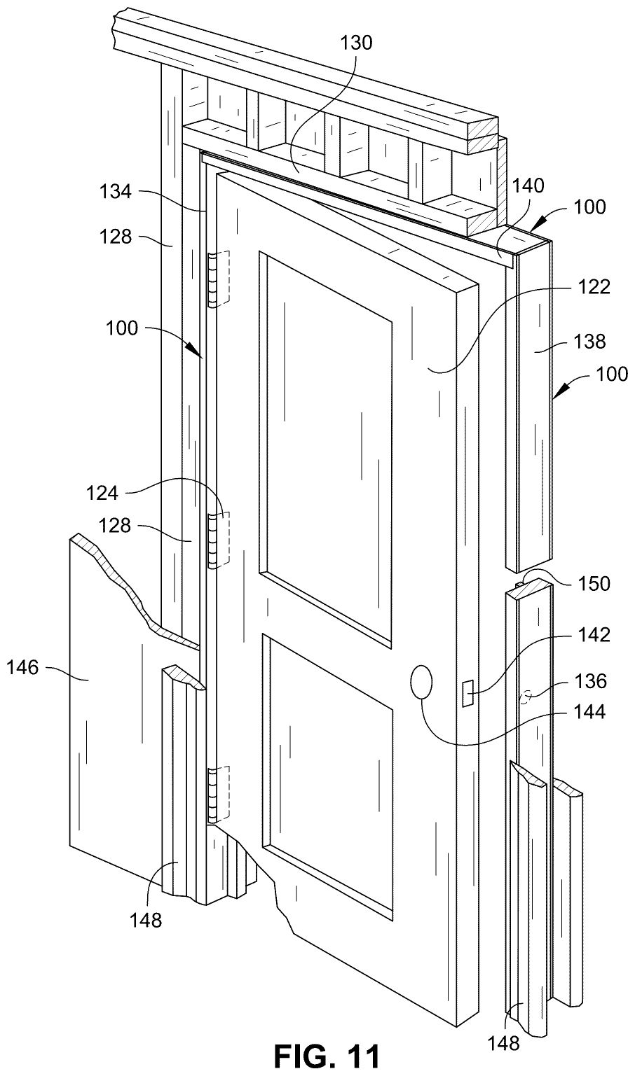

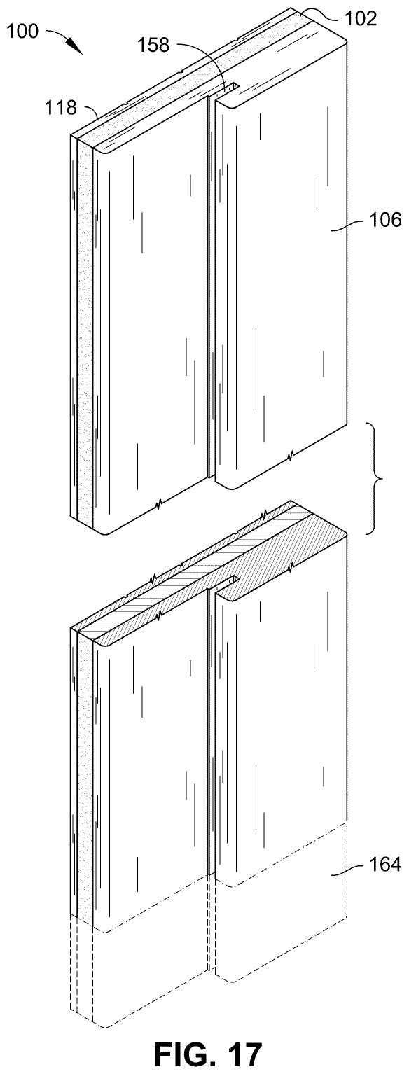

Referring generally to FIGS. 1 through 18, blended (e.g., dual-layered, multi-layered) trim molding assemblies, such as door jamb assemblies 100 for a door jamb set are described. For example, a door jamb assembly 100 can be configured as a flat door jamb. A door jamb assembly 100 can include a first layer 102 (backing layer, core) of engineered wood material/thermoplastic having a first, generally rectangular cross-sectional thickness 104, and a second layer 106 (facing layer, face) of wood material having a second, generally rectangular cross-sectional thickness 108. In embodiments of the disclosure, the second layer 106 is connected (e.g., bonded, joined) to the first layer 102 at a planar interface 110. Together, the first layer 102 and the second layer 106 have a total thickness 112.

As described herein, the first, generally rectangular cross-sectional thickness 104 of the first layer 102 may be greater than or equal to at least about fifty percent (50%) of the total thickness 112 of the first layer 102 and the second layer 106 together. For example, in some embodiments, the first, generally rectangular cross-sectional thickness 104 can be greater than or equal to about fifty percent (50%) of the total thickness 112, fifty-three percent (53%) of the total thickness 112, fifty-five percent (55%) of the total thickness 112, fifty-seven percent (57%) of the total thickness 112, fifty-nine percent (59%) of the total thickness 112, sixty-one percent (61%) of the total thickness 112, sixty-three percent (63%) of the total thickness 112, sixty-five percent (65%) of the total thickness 112, sixty-seven percent (67%) of the total thickness 112, sixty-nine percent (69%) of the total thickness 112, seventy-one percent (71%) of the total thickness 112, seventy-three percent (73%) of the total thickness 112, seventy-five percent (75%) of the total thickness 112, and so on.

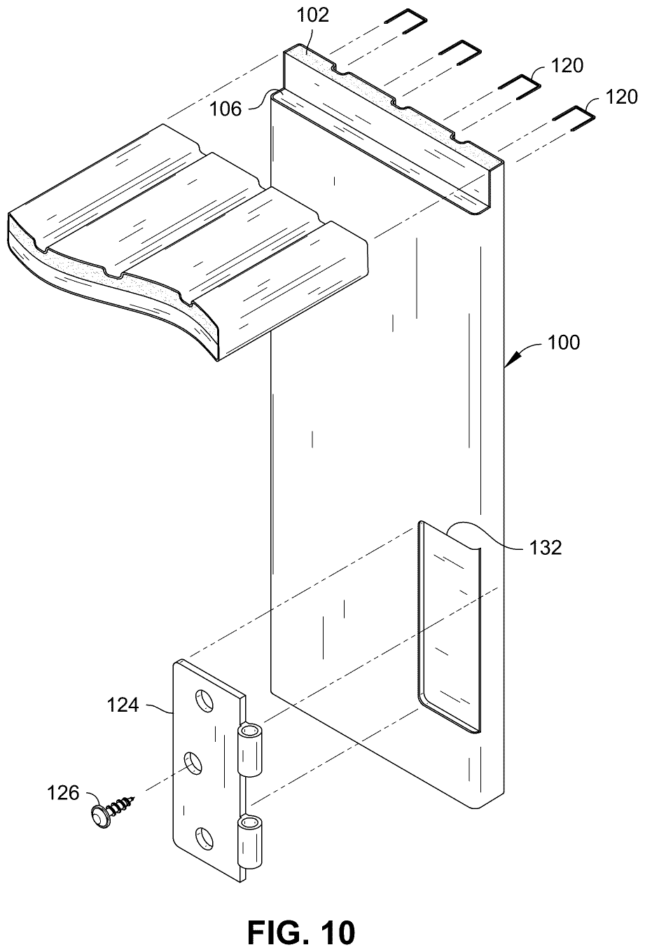

In some embodiments, the second layer 106 of wood material is glued (e.g., using an adhesive binder or another adhesive) to the first layer 102 of engineered wood material/thermoplastic at the planar interface 110. A press or other equipment may be used to force the first and second layers 102 and 106 together during the gluing process. In embodiments, the first layer 102 of engineered wood material can be a thermoplastic material, such as a polyvinyl chloride (PVC) material, or another thermoplastic material. In some embodiments, the second layer 106 of wood material can be laminated lumber, e.g., laminated vencer lumber (LVL). The second layer 106 of wood material can also be milled lumber material (e.g., pine wood). In some embodiments, the second layer 106 of wood material can include multiple segments fastened together (e.g., finger-jointed wood), particle board, fiberboard, and so forth. As described herein, the second layer 106 of wood material has superior screw pull strength to the first layer 102 of engineered wood material/thermoplastic, and/or is more capable of securing staples 120 (FIG. 10) and/or other fasteners, such as nails, that connect the door jamb assembly 100 to, for example, a head jamb connected at a dado to a vertical jamb. Additionally, in the case of a milled lumber second layer 106, a first layer 102 of thermoplastic may provide added dimensional stability to the door jamb assembly 100, e.g., lessening warp and/or twist found in all-wood jambs.

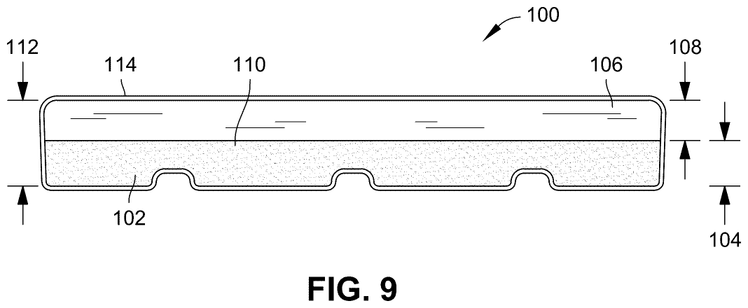

In some embodiments, the first layer 102 of engineered wood material can be thermoplastic formed from a panel having a thickness of about nine millimeters (9 mm) and the second layer 106 of wood material can be LVL and/or pine wood formed from a panel or panels having a thickness of about eight millimeters (8 mm) (e.g., as described with reference to FIG. 9). The thicknesses of nine millimeters (9 mm) and eight millimeters (8 mm) for the first and second layers 102 and 106, respectively, are provided by way of example and are not meant to limit the present disclosure. For example, the first layer 102 of engineered wood material/thermoplastic can have a thickness between about six millimeters (6 mm) and about twelve millimeters (12 mm) (e.g., about 6 mm, 7 mm, 8 mm, 9 mm, 10 mm, 11 mm, 12 mm), and the second layer 106 of wood material can have a thickness between about two millimeters (2 mm) and about eight millimeters (8 mm) (e.g., about 2 mm, 3 mm, 4 mm, 5 mm, 6 mm, 7 mm, 8 mm). Together, the total thickness 112 of a door jamb assembly 100 may be between about sixteen millimeters (16 mm) and about eighteen millimeters (18 mm) (e.g., about 16 mm, 17 mm, 18 mm).

After the first and second layers 102 and 106 are adhered together (e.g., as panels), one or more coatings of primer 114 can be applied to the assembled panels. In some embodiments, assembled panels can be cut (e.g., into strips) to form the door jamb assemblies 100. For example, assembled, laminated panels can be cut (e.g., ripped) into strips about five inches (5″) wide. Next, the strips may be run through a wood molder to form a shaped door jamb, coated with primer 114, and then dado cut. By way of example, a process for laminating the first layer 102 of engineered wood material/thermoplastic and the second layer 106 of wood material together can include cleaning both surfaces of dust and debris, e.g., at surfaces that form the planar interface 110. Both surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

As described herein, door jamb assemblies 100 can be used for exterior doorway applications. For example, a door 122 can be attached to an exterior door jamb assembly 100 by hinges 124 fastened to the door jamb assembly 100 by fasteners (e.g., screws 126) extending into the door jamb assembly 100. A door jamb assembly 100 can also include other hardware, such as a strike plate and so forth. A door jamb assembly 100 can be fastened to the doorframe by fasteners (e.g., nails) extending through a side of the door jamb assembly 100 and into the framing studs (e.g., jack stud 128) and/or header 130 of the doorframe. For example, a doorframe may be formed by a king stud 128 and a jack stud 128 on one side of the doorframe (with additional framing studs mirrored on the other side of the doorframe) and a header 130 at the top of the doorframe. The side of the door jamb set formed by a door jamb assembly 100 that attaches the hinges 124 can include hinge cutouts 132 and forms a hinge jamb 134. In other embodiments, the door jamb assembly 100 does not necessarily include the hinge cutouts 132. For instance, cutouts may be added during installation of the door 122. The other side of the door jamb set formed by a door jamb assembly 100 that attaches the strike plate can include a mortise 136 (e.g., for the strike plate) and forms a latch jamb 138. The top of the door jamb set formed by a door jamb assembly 100 forms a head jamb 140. The door can include a latch bolt bore 142 for a latch bolt to interface with the strike plate/mortise 136 and a lockset bore 144. After the door jamb set is anchored to the rough opening, finishes such as drywall 146 and casings 148 can be added to complete the installation.

In some embodiments, the second layer 106 of wood material may include one or more surface features, such as a stop 150. In some embodiments, the second layer 106 of wood material may also have one or more smooth exterior surfaces. Further, the edges and/or sides of the door jamb assembly 100 may include various edge details, including, but not necessarily limited to: back beveled details, square details, trim guide details, and so on. For instance, edge details may be provided for resting and/or registering the casing 148.

In some embodiments, a first layer 102 of engineered wood material/thermoplastic can be formed using a process such as extrusion. For example, the first layer 102 of engineered wood material may be formed using one or more extruded plastic materials, vinyl materials, polyvinyl chloride (PVC) materials, fiber glass materials, and so forth. Various surface features and/or contours may be formed in an extruded first layer 102 of engineered wood material/thermoplastic (e.g., using various mold and/or press features). Different surface finishes and/or treatments may be applied to the first layer 102 of engineered wood material/thermoplastic. For example, one or more layers of primer, paint, and/or stain can be applied to the surface of the first layer 102 of engineered wood material/thermoplastic. An exterior door jamb assembly 100 may be sold as a primed and ready-to-paint unit.

The second layer 106 can be formed of a wood material (e.g., scrap wood), a composite material (e.g., particle board (PB), plywood, laminated veneer lumber (LVL), wafer board, finger-jointed wood, and so forth) having a generally rectangular cross-sectional area. For example, the second layer 106 of wood material can be cut to fit and then glued to the first layer 102 of engineered wood material/thermoplastic. In some embodiments, the second layer 106 of wood material can be a wood including, but not necessarily limited to: Fir, Redwood, Cedar, Oak, Maple, Pine, Radiata Pine, Poplar, Hemlock, Lauan, and so forth. In some embodiments, the density of the second layer 106 may be between about two hundred kilograms per cubic meter (200 kg/m³) and about seven hundred and fifty kilograms per cubic meter (750 kg/m³).

In some embodiments, the second layer 106 of wood material can be made of particle board. In some embodiments, the second layer 106 of wood material can be made of a laminated lumber, such as plywood. Further, in some embodiments, reinforcing blocks of a different material (e.g., milled lumber) can be positioned proximate to key areas of a jamb (e.g., behind a hinge 124). For example, milled lumber may have better screw holding ability compared to, for example, particle board, and milled lumber may be used behind a hinge 124 while particle board or another less expensive material is used for the remainder of the second layer 106 of wood material. In another example, plywood, LVL, or wafer board may have better screw holding ability and/or moisture resistance compared to particle board, and one or more of these materials (e.g., plywood, LVL, wafer board) may be used behind a hinge 124 while particle board and/or another less expensive material is used for the remainder of the second layer 106 of wood material. LVL, finger-jointed wood and/or other materials that exhibit dimensional stability may also be desirable for strategic positioning along the second layer 106 of wood material.

The techniques and apparatus of the present disclosure may provide for improved raw material utilization. For example, wood residuals, particle board, and/or MDF segments used for the second layer 106 of wood material may be milled from smaller sections of wood (e.g., as opposed to typical door jambs and stops, which are milled from larger sections of wood). Further, in embodiments where the second layer 106 of wood material has a generally rectangular cross-sectional profile, the second layer 106 of wood material may be cut from a standard thickness flat panel by sawing rather than by milling larger wood sections using, for instance, a molder.

In some embodiments, a door stop can be nailed or stapled into the face of a door jamb through the face of the stop. For example, a door jamb assembly 100 may be formed with a flat jamb, and an additional stop 150 may be nailed onto the jamb. The holes are then filled prior to finishing (e.g., painting) the door jamb. In some embodiments, there are not necessarily holes through the stop 150 that are filled.

It should also be noted that the surface of a molded door jamb assembly 100 can be matched to the surface of, for example, a molded 6-panel door (e.g., a door having an MDF exterior). For instance, a door jamb assembly 100 can have a primer coat applied, which may be similar or comparable to the door mating to the door jamb assembly 100. The door jamb assembly 100 can also have a surface texture, such as an embossed wood grain pattern or another surface texture, similar to or comparable to the door mating to the door jamb assembly 100. Additionally, the incidence of typical wood distortion found in existing wood products, e.g., cupping, warping, twisting, crooking, and so forth, may be reduced or eliminated, e.g., due to the shape of the composite first layer 102 of engineered wood material/thermoplastic, which can stabilize the second layer 106 of wood material. Further, in some embodiments, a first layer 102 of engineered wood material/thermoplastic may include structural features configured to further strengthen a door jamb assembly 100 and/or reduce or minimize dimensional distortion/cupping. For example, one or more features, such as longitudinal channels and/or grooves 116 may be formed in the first layer 102 of engineered wood material/thermoplastic (e.g., on a back side of the first layer 102 of engineered wood material/thermoplastic. In some embodiments, the grooves 116 may run the length of the first layer 102 of engineered wood material/thermoplastic.

Additionally, improved utilization of wood and/or reduction of material waste of wood over typical manufacturing may be achieved using the systems, techniques, and apparatus disclosed herein. Also, areas with an abundant wood fiber supply but a lesser supply of larger sections of wood for milling one-piece jamb parts can benefit from the ability to locally manufacture the door jamb assemblies 100 disclosed herein, incurring, for example, reduced shipping costs due to domestic production. It should also be noted that the defect rate may be reduced (e.g., in comparison to milling wood components) as described herein.

In some embodiments, the edges and/or sides of a door jamb assembly 100 may be back beveled, square, trim guide, and so forth. Further, the width of a door jamb assembly 100 can vary based upon, for instance, door opening size, wall thickness, and so forth. The shape of the stop 150 may also vary. For example, the stop 150 may be colonial shaped. In some embodiments, a stop 150 may also have square edges. However, these shapes are provided by way of example and are not meant to limit the present disclosure. In other embodiments, a stop 150 may have a different shape, including, but not necessarily limited to: a one-radius edge, a two-radius edge, and so forth. The width and/or height of a stop 150 may also vary. Further, the door jamb assembly 100 may have different end work, including, but not necessarily limited to: a straight cut, a miter cut, a coped end cut, and so forth.

In some embodiments, during assembly (e.g., of a door jamb set), the second layer 106 of wood material can be routed into, and a hinge 124 can be attached to the door jamb using fasteners (e.g., screws 126) connected through the first layer 102 of engineered wood material/thermoplastic. However, routing through a door jamb assembly 100 during assembly is provided by way of example and is not meant to limit the present disclosure. In other embodiments, a door jamb assembly 100 may be machined/finished (e.g., for hinges 124) prior to sale and/or assembly as a door jamb set. The door jamb set formed of the door jamb assemblies 100 can include the door 122, and the pre-hung door can be attached to the door opening by fastening (e.g., nailing or screwing) through the flat of the jamb, i.e., through the second layer 106 of wood material, through the first layer 102 of engineered wood material/thermoplastic, and into the door rough opening.

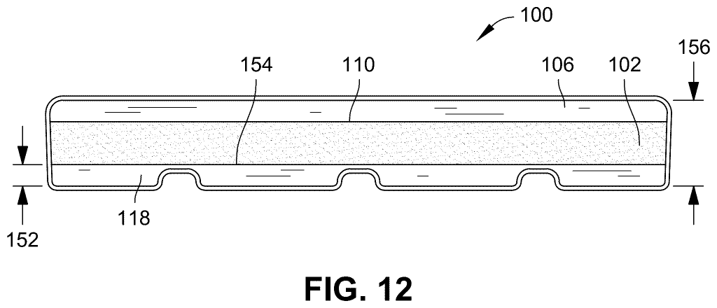

With reference to FIG. 12, in some embodiments, a door jamb assembly 100 can also have a third layer 118 of wood material having a third, generally rectangular cross-sectional thickness 152. In embodiments of the disclosure, the third layer 118 is connected (e.g., bonded, joined) to the first layer 102 at another planar interface 154 (e.g., opposite the planar interface 110). As previously described with reference to the second layer 106 of wood material, the third layer 118 of wood material can be laminated lumber (e.g., LVL), milled lumber material (e.g., Fir, Redwood, Cedar, Oak, Maple, pine wood such as Radiata Pine, Poplar, Hemlock, Lauan), and so forth. In some embodiments, the third layer 118 can be the same or similar material or materials as the second layer 106 and/or can be different wood material(s). In some embodiments, the third layer 118 of wood material can include multiple segments fastened together (e.g., finger-jointed wood), particle board, fiberboard, and so forth. The third layer 118 of wood material can be glued (e.g., using an adhesive binder or another adhesive) to the first layer 102 of engineered wood material/thermoplastic at the planar interface 154. A press or other equipment may be used to force the first, second, and third layers 102, 106, and 118 together during the gluing process. By way of example, a process for laminating the first layer 102 of engineered wood material/thermoplastic and the second and third layers 106 and 118 of wood material together can include cleaning the surfaces of dust and debris, e.g., at surfaces that form the planar interfaces 110 and 154. The surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

Together, the first layer 102, the second layer 106, and the third layer 118 have a total thickness 156. In some embodiments, the total thickness 156 of the first layer 102, the second layer 106, and the third layer 118 may be between about sixteen millimeters (16 mm) and about eighteen millimeters (18 mm) (e.g., about 16 mm, 17 mm, 18 mm). In example embodiments where there is a second layer 106 and a third layer 118 of wood materials, the layers 106 and 118 may have at least approximately the same thickness. In other embodiments, the layers 106 and 118 may not necessarily have the same or similar thickness. For example, the first layer 102 of engineered wood material/thermoplastic can have a thickness between about six millimeters (6 mm) and about twelve millimeters (12 mm) (e.g., about 6 mm, 7 mm, 8 mm, 9 mm, 10 mm, 11 mm, 12 mm); the second layer 106 of wood material can have a thickness between about two millimeters (2 mm) and about eight millimeters (8 mm) (e.g., about 2 mm, 3 mm, 4 mm, 5 mm, 6 mm, 7 mm, 8 mm); and the third layer 118 of wood material can have a thickness between about two millimeters (2 mm) and about eight millimeters (8 mm) (e.g., about 2 mm, 3 mm, 4 mm, 5 mm, 6 mm, 7 mm, 8 mm).

As described herein, the combined, generally rectangular cross-sectional thicknesses 108 and 152 of the second layer 106 and the third layer 118 of wood materials may be greater than or equal to at least about twenty-five percent (25%) of the total thickness 156 of the first layer 102, the second layer 106, and the third layer 118. For example, in some embodiments, the combined, generally rectangular cross-sectional thicknesses 108 and 152 can be greater than or equal to about twenty-five percent (25%) of the total thickness 156, twenty-seven percent (27%) of the total thickness 156, twenty-nine percent (29%) of the total thickness 156, thirty-one percent (31%) of the total thickness 156, thirty-three percent (33%) of the total thickness 156, thirty-five percent (35%) of the total thickness 156, thirty-seven percent (37%) of the total thickness 156, thirty-nine percent (39%) of the total thickness 156, forty-one percent (41%) of the total thickness 156, forty-three percent (43%) of the total thickness 156, forty-five percent (45%) of the total thickness 156, forty-seven percent (47%) of the total thickness 156, forty-nine percent (49%) of the total thickness 156, fifty-one percent (51%) of the total thickness 156, fifty-three percent (53%) of the total thickness 156, fifty-five percent (55%) of the total thickness 156, fifty-seven percent (57%) of the total thickness 156, fifty-nine percent (59%) of the total thickness 156, sixty-one percent (61%) of the total thickness 156, sixty-three percent (63%) of the total thickness 156, sixty-five percent (65%) of the total thickness 156, sixty-seven percent (67%) of the total thickness 156, and so on. It will be appreciated that in these examples, the first, generally rectangular cross-sectional thickness 104 of the first layer 102 of engineered wood/thermoplastic can be greater than or equal to about thirty-three percent (33%) of the total thickness 156 and less than or equal to about seventy-five percent (75%) of the total thickness 156.

While the description herein has detailed door jamb assemblies 100 including jambs and stops 150 for exterior doorway applications with some specificity, it is noted that these particular trim molding applications are provided by way of example and are not meant to limit the present disclosure. In other embodiments, the systems, techniques, and apparatus described herein can be used for various other exterior trim molding applications.

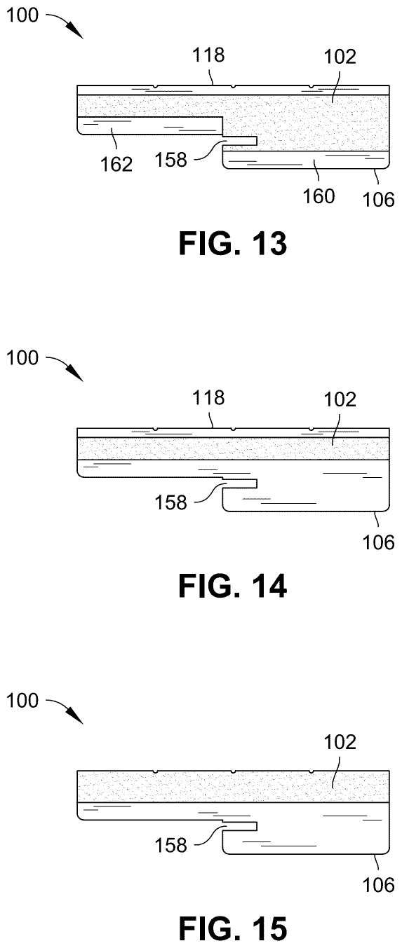

Referring now to FIGS. 13 through 18, single rabbet (SR) door jamb assemblies 100 for a door jamb set are described. The door jamb assemblies 100 can include a rabbet 158, which can be defined as a recess, groove, or kerf, cut or otherwise formed in a door jamb assembly 100. For example, a rabbet 158 formed in a door jamb assembly 100 can be used for compressing a portion of weatherstripping fastened to the door jamb assembly 100 and used to seal around an exterior door. In some embodiments, a rabbet 158 can have a kerf width of about one-eighth of an inch (0.125″) and a reach of about one-half of an inch (0.5″). However, these dimensions are provided by way of example and are not meant to limit the present disclosure. In other embodiments, a rabbet 158 can have different dimensions.

As described herein, a door jamb assembly 100 can include a first layer 102 of engineered wood material/thermoplastic (e.g., PVC as previously described) and a second layer 106 of LVL and/or another wood material (e.g., finger jointed, laminated, etc. as previously described). In some embodiments, a door jamb assembly 100 may also include a third layer 118 of LVL and/or another wood material (e.g., finger jointed, laminated, etc. as previously described). As described herein, the first layer 102, the second layer 106, and/or the third layer 118 can be bound together using an adhesive, such as glue, and will not easily delaminate. In some embodiments, the first layer 102 of engineered wood material/thermoplastic may be formed from multiple sheets of thermoplastic (e.g., multiple layers of PVC glued together).

In some embodiments, the second layer 106 of wood material may be routed into for a hinge 124, which can be attached to the door jamb using fasteners connected to the second layer 106 of wood material and/or the third layer 118 of wood material. In some embodiments, the second layer 106 of wood material may be thick enough that there is still wood material left in the area beneath the hinge 124 after routing. In some embodiments, the second layer 106 can be routed into during assembly. In some embodiments, a door jamb assembly 100 may be machined/finished (e.g., for hinges 124) prior to sale and/or assembly as a door jamb set (e.g., as previously described).

Different surface finishes and/or treatments may be applied to the second layer 106 of wood material and/or the third layer 118 of wood material. For example, one or more layers of primer, paint, and/or stain can be applied to the surface of the second layer 106 of wood material and/or the third layer 118 of wood material. As described, an exterior door jamb assembly 100 may be sold as a primed and ready-to-paint unit. In some embodiments, the thermoplastic material forming the first layer 102 may be colored (e.g., white, brown, beige, etc.) using one or more pigments added to the thermoplastic.

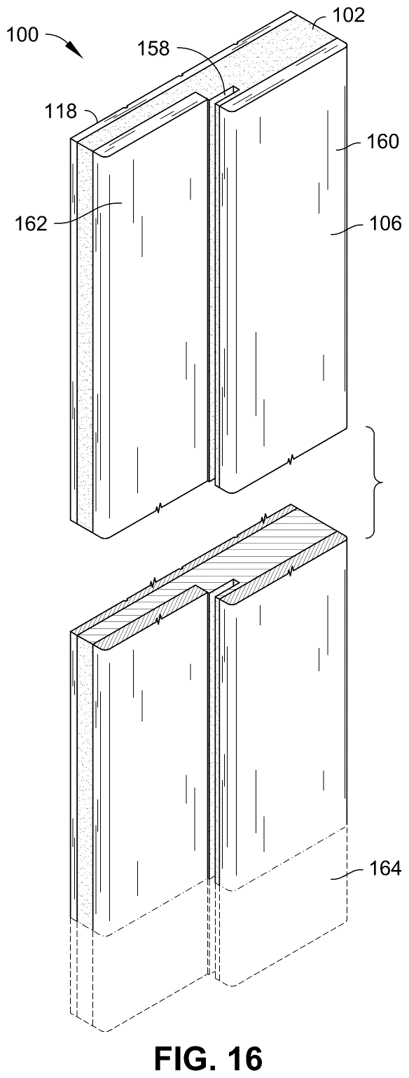

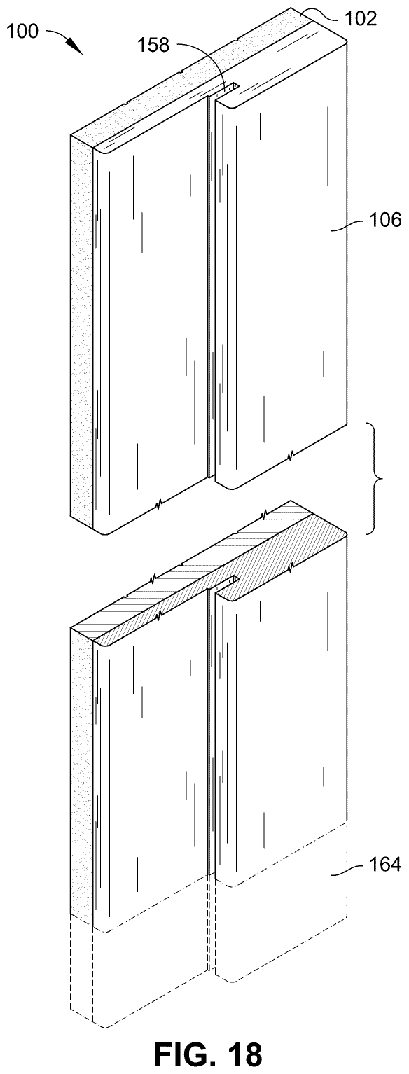

It should be noted that the second layer 106 of wood material may be discontinuous (e.g., with a first segment 160 extending from one edge of a door jamb assembly 100 across the rabbet 158 and stopping at the opening of the rabbet 158, with another segment 162 extending from proximate to the opening of the rabbet 158 to the other edge of the door jamb assembly 100, e.g., as described with reference to FIGS. 13 and 16. In embodiments, the second layer 106 as described with reference to FIGS. 13 through 18 provides a paintable, machinable surface. As described with reference to FIGS. 13, 14, 16, and 17, a third layer 118 of wood material may provide additional structural support for a door jamb assembly 100, but is not necessarily included (e.g., as described with reference to FIGS. 15 and 18). In embodiments where an outer first layer 102 of engineered wood material/thermoplastic hides an inner third layer 118 of wood material, the third layer 118 may be rough and/or unfinished (e.g., not finely milled on all sides). For instance, the third layer 118 of wood material can be formed from edge glued blocks, finger jointed blocks, and so forth.

It should be noted that while single rabbet door jamb assemblies 100 has been described herein with some specificity, in other embodiments, more than a single rabbet may be provided in a door jamb assembly 100 (e.g., a double rabbet, etc.). In some embodiments, a door jamb assembly 100 can include a secondary length of material 164, which can be formed of a composite material and positioned, for example, at the base of a door jamb assembly 100. In some embodiments, the secondary length of material 164 is connected to the door jamb assembly 100 using an interlocking connection technique, including, but not necessarily limited to, finger jointing. However, finger jointing is provided by way of example and is not meant to limit the present disclosure. In other embodiments, the secondary length of material 164 can be joined to the first layer 102, the second layer 106, and/or the third layer 118 using various other connection techniques.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A blended trim molding assembly comprising:
a first layer of thermoplastic material having a first, generally rectangular cross-sectional thickness; and
a second layer of wood material having a second, generally rectangular cross-sectional thickness, the second layer of wood material joined to the first layer of thermoplastic material at a planar interface,
the first layer of thermoplastic material and the second layer of wood material having a total thickness,
the first, generally rectangular cross-sectional thickness greater than or equal to at least about thirty-three percent (33%) of the total thickness of the first layer of engineered wood material and the second layer of wood material, and
the first, generally rectangular cross-sectional thickness less than or equal to at least about seventy-five percent (75%) of the total thickness of the first layer of engineered wood material and the second layer of wood material.

2. The blended trim molding assembly as recited in claim 1, wherein the second layer of wood material is glued to the first layer of thermoplastic material.

3. The blended trim molding assembly as recited in claim 1, wherein the blended trim molding assembly is configured as a door jamb.

4. The blended trim molding assembly as recited in claim 1, wherein the first layer of thermoplastic material comprises polyvinyl chloride (PVC).

5. The blended trim molding assembly as recited in claim 1, wherein the second layer of wood material comprises laminated lumber.

6. The blended trim molding assembly as recited in claim 1, wherein the second layer of wood material comprises milled lumber material.

7. The blended trim molding assembly as recited in claim 1, further comprising a third layer of wood material having a third, generally rectangular cross-sectional thickness, the third layer of wood material joined to the first layer of thermoplastic material at a second planar interface opposite the planar interface.

8. The blended trim molding assembly as recited in claim 1, wherein the second layer of wood material comprises at least one rabbet.

9. The blended trim molding assembly as recited in claim 1, further comprising a secondary length of material connected to the first layer of thermoplastic material and the second layer of wood material.

10. A method of forming a blended trim molding assembly, the method comprising:
forming a first layer of thermoplastic material having a first, generally rectangular cross-sectional thickness;
forming a second layer of wood material having a second, generally rectangular cross-sectional thickness; and
joining the second layer of wood material to the first layer of thermoplastic material at a planar interface,
the first layer of thermoplastic material and the second layer of wood material having a total thickness,
the first, generally rectangular cross-sectional thickness greater than or equal to at least about thirty-three percent (33%) of the total thickness of the first layer of engineered wood material and the second layer of wood material, and
the first, generally rectangular cross-sectional thickness less than or equal to at least about seventy-five percent (75%) of the total thickness of the first layer of engineered wood material and the second layer of wood material.

11. The method as recited in claim 10, where joining the second layer of wood material to the first layer of thermoplastic material comprises gluing the second layer of wood material to the first layer of thermoplastic material.

12. The method as recited in claim 10, wherein the blended trim molding assembly is configured as a door jamb.

13. The method as recited in claim 10, wherein the first layer of thermoplastic material comprises polyvinyl chloride (PVC).

14. The method as recited in claim 10, wherein the second layer of wood material comprises laminated lumber.

15. The method as recited in claim 10, wherein the second layer of wood material comprises milled lumber material.

16. The method as recited in claim 10, further comprising forming a third layer of wood material having a third, generally rectangular cross-sectional thickness; and joining the third layer of wood material to the first layer of thermoplastic material at a second planar interface opposite the planar interface.

17. The method as recited in claim 10, further comprising forming at least one rabbet in the second layer of wood material.

18. The method as recited in claim 10, further comprising connecting a secondary length of material to the first layer of thermoplastic material and the second layer of wood material.

19. A blended door jamb assembly comprising:
a first layer of thermoplastic material having a first, generally rectangular cross-sectional thickness;
a second layer of wood material having a second, generally rectangular cross-sectional thickness, the second layer of wood material joined to the first layer of thermoplastic material at a first planar interface, the second layer of wood material having at least one rabbet; and
a third layer of wood material having a third, generally rectangular cross-sectional thickness, the third layer of wood material joined to the first layer of thermoplastic material at a second planar interface opposite the first planar interface, the first layer of thermoplastic material, the second layer of wood material, and the third layer of wood material having a total thickness,
the first, generally rectangular cross-sectional thickness and the third, generally rectangular cross-sectional thickness together greater than or equal to at least about twenty-five percent (25%) of the total thickness of the first layer of engineered wood material, the second layer of wood material, and the third layer of wood material, and
the first, generally rectangular cross-sectional thickness and the third, generally rectangular cross-sectional thickness together less than or equal to at least about sixty-seven percent (67%) of the total thickness of the first layer of engineered wood material, the second layer of wood material, and the third layer of wood material.

20. The blended door jamb assembly as recited in claim 19, wherein the second layer of wood material is discontinuous, having a first segment extending from one edge of the door jamb assembly across the rabbet and stopping at an opening of the rabbet, and a second segment extending from proximate to the opening of the rabbet to the other edge of the door jamb assembly.
